(19) United States
(12) Patent Application Publication
(10) Pub. No.: US 2019/0335019 A1
(43) Pub. Date: Oct. 31, 2019

(54) DAMPING TRANSMISSION REQUIREMENT VARIATIONS

(71) Applicant: Google LLC, Mountain View, CA (US)

(72) Inventors: Eugene Vladimir Davydov, Belmont, CA (US); Patrick Hummel, Cupertino, CA (US); Jean-Francois Crespo, Palo Alto, CA (US); Shaohua Sun, Palo Alto, CA (US); Christopher Davis Monkman, Sunnyvale, CA (US); Derek Leslie-Cook, San Francisco, CA (US)

(21) Appl. No.: 15/962,502

(22) Filed: Apr. 25, 2018

(51) Int. Cl. H04L 29/06

(52) U.S. Cl. CPC H04L 69/08; H04L 69/18; H04L 69/24; H04L 69/04

(57) ABSTRACT

Methods, systems, and apparatus, including computer programs encoded on a computer storage medium, for determining an adjusted requirement for transmission of a given digital component. In one aspect, a system includes a damping subsystem that obtains, from an evaluation subsystem, a standard requirement for transmission of the given digital component. The damping subsystem also obtains, from a prediction subsystem, a predicted requirement for transmission of the given digital component. The damping subsystem determines whether a damping condition is met. When the damping condition is met, the damping subsystem determines the adjusted requirement based on at least the predicted requirement. When the damping condition is not met, the damping subsystem determines the adjusted requirement based on at least the standard requirement.

### BACKGROUND

This specification relates to damping transmission requirement variations.

The Internet facilitates the exchange of information between users across the globe. This exchange of information enables one or more digital resources to be accessed by multiple distributed users such that digital resources and content can be shared by the users. For example, in a cloud computing environment access may be provided to multiple users to a shared pool of configurable system resources and services such as data storage and data processing.

Additionally, content from multiple different providers can be integrated into a single electronic document to create a composite document. For example, a portion of the content included in the electronic document may be selected (or specified) by a publisher of the electronic document. A different portion of content (e.g., third party content) can be provided by a third party (e.g., an entity that is not a publisher of the electronic document).

### SUMMARY

This specification describes a system implemented as computer programs on one or more computers in one or more locations that determines adjusted requirements for transmissions of digital components.

According to a first aspect there is provided a system including an evaluation subsystem that is configured to determine a standard requirement for transmission of a given digital component. The system further includes a prediction subsystem that is configured to determine a predicted requirement for transmission of the given digital component. The system further includes a damping subsystem that is configured to determine an adjusted requirement for transmission of the given digital component.

The damping subsystem obtains, from the evaluation subsystem, the standard requirement for transmission of the given digital component as determined by the evaluation subsystem. The damping subsystem obtains, from the prediction subsystem, the predicted requirement for transmission of the given digital component as determined by the prediction subsystem. The damping subsystem determines: (i) a cumulative measure of standard requirements for one or more previous transmissions of digital components, and (ii) a cumulative measure of adjusted requirements for the one or more previous transmissions of digital components. The damping subsystem determines whether a damping condition is met based on at least: (i) the cumulative measure of standard requirements for previous transmissions of digital components, and (ii) the cumulative measure of adjusted requirements for previous transmissions of digital components. The damping subsystem determines the adjusted requirement based on at least the predicted requirement when the damping condition is met, and determines the adjusted requirement based on at least the standard requirement when the damping condition is not met.

In some implementations, the damping subsystem determines an updated cumulative measure of standard requirements based on the cumulative measure of standard requirements and the standard requirement for transmission of the given digital component. The damping subsystem further determines an updated cumulative measure of adjusted requirements based on the cumulative measure of adjusted requirements and the predicted requirement for transmission of the given digital component. The damping subsystem determines whether a threshold of similarity between the updated cumulative measure of standard requirements and the updated cumulative measure of adjusted requirements is met. The damping subsystem determines the damping condition is met based on at least the threshold similarity being met, and determines the damping condition is not met based on at least the threshold similarity not being met.

In some implementations, the damping subsystem determines an updated cumulative measure of standard requirements based on the cumulative measure of standard requirements and the standard requirement for transmission of the given digital component. The damping subsystem determines an updated cumulative measure of adjusted requirements based on the cumulative measure of adjusted requirements and the predicted requirement for transmission of the given digital component. The damping subsystem determines whether the updated cumulative measure of adjusted requirements is less than the updated cumulative measure of standard requirements. The damping subsystem determines the damping condition is met based on at least the updated cumulative measure of adjusted requirements being less than the updated cumulative measure of standard requirements, and determines the damping condition is not met based on at least the updated cumulative measure of adjusted requirements not being less than the updated cumulative measure of standard requirements.

In some implementations, the damping subsystem determines whether additional formats would be applied to the digital component if the adjusted requirement were determined to be the predicted requirement. The damping subsystem determines the damping condition is met based on at least additional formats being applied if the adjusted requirement were determined to be the predicted requirement, and determines the damping condition is not met based on at least additional formats not being applied if the adjusted requirement were determined to be the predicted requirement.

In some implementations, the predicted requirement for transmission of the given digital component is determined to be an average of previous standard requirements for transmissions of digital components.

In some implementations, the predicted requirement for transmission of the given digital component is determined to be a requirement level at which the given digital component is capable of obtaining all available formats.

In some implementations, determining the predicted requirement for transmission of the given digital component includes updating the predicted requirement based on the standard requirement to cause a similarity between the updated predicted requirement and the standard requirement to exceed a threshold.

In some implementations, the given digital component is formatted based on the adjusted requirement.

According to a second aspect there is provided a method for determining a standard requirement for transmission of a given digital component that includes performing the operations of the previously described system.

According to a third aspect there is provided a non-transitory computer storage medium storing instructions executable by a data processing apparatus and that upon such execution cause the data processing apparatus to perform operations including the operations of the previously described system.

Particular embodiments of the subject matter described in this specification can be implemented so as to realize one or more of the following advantages.

The damping system as described in this specification determines digital component transmission requirements that may exhibit less variance for similar transmissions than transmission requirements determined by conventional systems. Transmissions may be referred to as similar based on similarities between the characteristics of the transmissions, such as the component requests that triggered the transmissions, the digital component distribution criteria, the digital component presentation positions, and the like. By reducing the variance between transmission requirements for similar transmissions, the damping system as described in this specification provide a more stable digital component distribution environment over time and may enable more formats to be applied to digital components than would otherwise be the case (e.g., if the transmission requirements were determined by conventional systems and therefore exhibited greater variance). Since formats increase the utility of digital components, for example, by increasing the rate of user interactions with the digital components, the utility of digital components with transmission requirements determined by the damping system as described in this specification may be greater than the utility of digital components with transmission requirements determined by conventional systems.

Moreover, the damping system as described in this specification can prevent unacceptably large discrepancies between the average transmission requirement (or any other cumulative measure of transmission requirements) determined by the damping system and the average transmission requirement determined by a conventional system for similar transmissions. Therefore, the damping system as described in this specification may, in some cases, be seamlessly integrated into a digital component distribution system where transmission requirements were previously determined by a conventional system, without changing average transmission requirements for similar transmissions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which digital components are distributed.

FIG. 2 is a block diagram of an example data flow for determining an adjusted requirement for a transmission of a digital component and for determining formats to be applied to the digital component.

FIG. 3 is a flow diagram of an example process for determining an adjusted requirement for transmission of a digital component and for determining formats to be applied to the digital component.

FIG. 4 is a block diagram of an example computing system.

Like reference numbers and designations in the various drawings indicate like elements.

### DETAILED DESCRIPTION

This specification describes a system implemented as computer programs on one or more computers in one or more locations that adjusts transmission requirements for digital components in order to reduce variations in the standard transmission requirements. The system can prevent unacceptably large discrepancies between the average of the adjusted transmission requirements and the average of the unadjusted transmission requirements.

As used throughout this document, the phrase “digital component” refers to a discrete unit of digital content or digital information (e.g., a video clip, audio clip, multimedia clip, image, text, or another unit of content). A digital component can be electronically stored in a physical memory device as a single file or in a collection of files, and digital components can take the form of video files, audio files, multimedia files, image files, or text files and include advertising information, such that an advertisement is a type of digital component. Generally, a digital component is defined by (or provided by) a single provider or source (e.g., an advertiser, publisher, or other content provider), but a digital component provided from one source could be enhanced with data from another source (e.g., weather information, real time event information, or other information obtained from another source).

Digital component distribution systems select digital components to be transmitted (e.g., to be integrated into electronic documents for display at user devices) in response to requests for digital components, as will be described in more detail below. Moreover, digital component distribution systems determine transmission requirements for digital components selected for transmission. A transmission requirement specifies an action to be performed by the provider of a digital component in response to a transmission of the digital component. For example, the transmission requirement may specify that the provider of the digital component submit an amount of compensation in response to the transmission of the digital component. In some cases, the amount of compensation specifies an amount to be submitted for each instance of specific events attributed to the presentation of the digital component (e.g., user interactions with the digital component). Other actions could include performance of a specified action or submission of another item or service.

A standard requirement for transmission of a digital component refers to a transmission requirement that is initially determined for the digital component by any conventional procedure for determining transmission requirements (e.g., an auction procedure). In some cases, standard requirements for digital component transmissions can exhibit high variance between different transmissions, even when the characteristics of the transmissions (e.g., digital component requests, digital component distribution criteria, digital component presentation positions, and the like) are similar. As will be described in more detail below, substantial variations in transmission requirements for similar digital component transmissions may result in uncertainty as to what transmission requirement will be assigned to each digital component transmission and may also result in transmitted digital components being allocated fewer formats than they otherwise would be (e.g., if they faced more consistent transmission requirements). Formats increase the utility of a digital component, for example, by enhancing the digital component, thereby increasing the rate of user interactions with the digital component. Application of a format to a digital component may include visually enhancing the digital component, audibly enhancing the digital component (e.g., adding audio content to the digital component), or otherwise enhancing/modifying the digital component to distinguish the digital component from other presented content.

After determining a standard requirement for transmission of a digital component, the digital component distribution system as described in this specification determines an adjusted requirement for transmission of the digital component. Generally, the adjusted transmission requirements may exhibit less variance between similar digital component transmissions than the standard transmission requirements, thereby enabling (in some cases) more formatting options to be applied to the transmitted digital components.

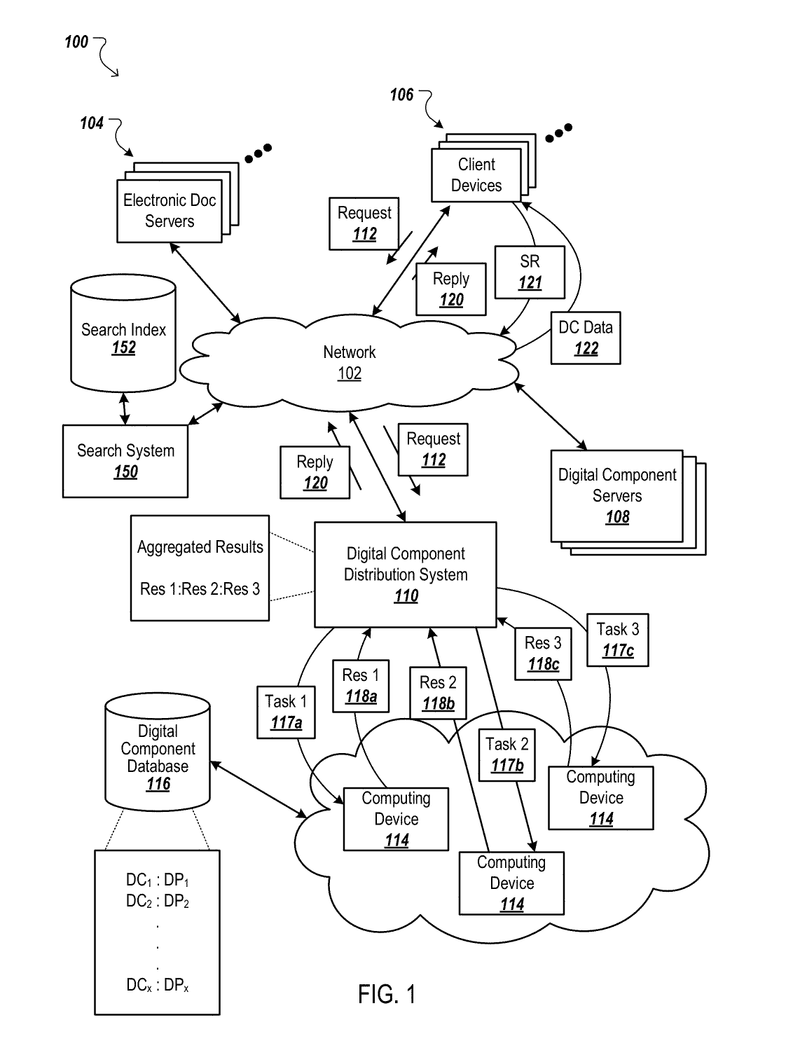

FIG. 1 is a block diagram of an example environment 100 in which digital components are distributed for presentation with electronic documents. The example environment 100 includes a network 102, such as a local area network (LAN), a wide area network (WAN), the Internet, or a combination thereof. The network 102 connects electronic document servers 104, client devices 106, digital component servers 108, and a digital component distribution system 110 (also referred to as a component distribution system). The example environment 100 may include many different electronic document servers 104, client devices 106, and digital component servers 108.

A client device 106 is an electronic device that is capable of requesting and receiving resources over the network 102. Example client devices 106 include personal computers, mobile communication devices, and other devices that can send and receive data over the network 102. A client device 106 typically includes a user application, such as a web browser, to facilitate the sending and receiving of data over the network 102, but native applications executed by the client device 106 can also facilitate the sending and receiving of data over the network 102.

An electronic document is data that presents a set of content at a client device 106. Examples of electronic documents include webpages, word processing documents, portable document format (PDF) documents, images, videos, search results pages, and feed sources. Native applications (e.g., “apps”), such as applications installed on mobile, tablet, or desktop computing devices are also examples of electronic documents. Electronic documents can be provided to client devices 106 by electronic document servers 104 (“Electronic Doc Servers”). For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally.

Electronic documents can include a variety of content. For example, an electronic document can include static content (e.g., text or other specified content) that is within the electronic document itself and/or does not change over time. Electronic documents can also include dynamic content that may change over time or on a per-request basis. For example, a publisher of a given electronic document can maintain a data source that is used to populate portions of the electronic document. In this example, the given electronic document can include one or more tags or scripts that cause the client device 106 to request content from the data source when the given electronic document is processed (e.g., rendered or executed) by a client device 106. The client device 106 integrates the content obtained from the data source into the given electronic document to create a composite electronic document including the content obtained from the data source.

In some situations, a given electronic document can include one or more digital component tags or digital component scripts that reference the digital component distribution system 110. In these situations, the digital component tags or digital component scripts are executed by the client device 106 when the given electronic document is processed by the client device 106. Execution of the digital component tags or digital component scripts configures the client device 106 to generate a request for one or more digital components 112 (referred to as a “component request”), which is transmitted over the network 102 to the digital component distribution system 110. For example, a digital component tag or digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the digital component distribution system 110 can use to select one or more digital components provided in response to the request. The component request 112 is transmitted, by the client device 106, over the network 102 (e.g., a telecommunications network) to a server of the digital component distribution system 110.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the digital component distribution system 110. Similarly, event data specifying keywords associated with the electronic document (“document keywords”) or entities (e.g., people, places, or things) that are referenced by the electronic document can also be included in the component request 112 (e.g., as payload data) and provided to the digital component distribution system 110 to facilitate identification of digital components that are eligible for presentation with the electronic document. The event data can also include a search query that was submitted from the client device 106 to obtain a search results page, and/or data specifying search results and/or textual, audible, or other visual content that is included in the search results.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The component distribution system 110 chooses digital components that will be presented with the given electronic document in response to receiving the component request 112 and/or using information included in the component request 112. In some implementations, a digital component is selected (using the techniques described herein) in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106. Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the digital component distribution system 110 is implemented in a distributed computing system that includes, for example, a server and a set of multiple computing devices 114 that are interconnected and identify and distribute digital components in response to requests 112. The set of multiple computing devices 114 operate together to identify a set of digital components that are eligible to be presented in the electronic document from a corpus of millions of available digital components (DC1-x). The millions of available digital components can be indexed, for example, in a digital component database 116. Each digital component index entry can reference the corresponding digital component and/or include distribution parameters (DP1-DPx) that contribute to (e.g., condition or limit) the distribution/transmission of the corresponding digital component. For example, the distribution parameters can contribute to the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. In other words, the distribution parameters are used to trigger distribution (e.g., transmission) of the digital components over the network 102. The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation.

The distribution parameters can also specify an eligibility value (e.g., ranking score, bid, or some other specified value) that is used for evaluating the eligibility of the digital component for distribution/transmission (e.g., among other available digital components), for example, by the component evaluation process. In some situations, the eligibility value can specify a maximum amount of compensation that a provider of the digital component is willing to submit in response to the transmission of the digital component (e.g., for each instance of specific events attributed to the presentation of the digital component, such as user interaction with the digital component).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the digital component distribution system 110. For example, the results 118a-118c provided by each of the computing devices in the set 114 may identify a subset of digital components that are eligible for distribution in response to the component request and/or a subset of the digital components that have certain distribution parameters. The identification of the subset of digital components can include, for example, comparing the event data to the distribution parameters, and identifying the subset of digital components having distribution parameters that match at least some features of the event data.

The digital component distribution system 110 aggregates the results 118a-118c received from the set of multiple computing devices 114 and uses information associated with the aggregated results to: (i) select one or more digital components that will be provided in response to the request 112, and (ii) determine transmission requirements for the one or more digital components. For example, the digital component distribution system 110 can select a set of winning digital components (one or more digital components) based on the outcome of one or more component evaluation processes. In turn, the digital component distribution system 110 can generate and transmit, over the network 102, reply data 120 (e.g., digital data representing a reply) that enables the client device 106 to integrate the set of winning digital components into the given electronic document, such that the set of winning digital components and the content of the electronic document are presented together at a display of the client device 106.

In some implementations, the client device 106 executes instructions included in the reply data 120, which configures and enables the client device 106 to obtain the set of winning digital components from one or more digital component servers. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

To facilitate searching of electronic documents, the environment 100 can include a search system 150 that identifies the electronic documents by crawling and indexing the electronic documents (e.g., indexed based on the crawled content of the electronic documents). Data about the electronic documents can be indexed based on the electronic document with which the data are associated. The indexed and, optionally, cached copies of the electronic documents are stored in a search index 152 (e.g., hardware memory device(s)). Data that are associated with an electronic document is data that represents content included in the electronic document and/or metadata for the electronic document.

Client devices 106 can submit search queries to the search system 150 over the network 102. In response, the search system 150 accesses the search index 152 to identify electronic documents that are relevant to the search query. The search system 150 identifies the electronic documents in the form of search results and returns the search results to the client device 106 in a search results page. A search result is data generated by the search system 150 that identifies an electronic document that is responsive (e.g., relevant) to a particular search query, and includes an active link (e.g., hypertext link) that causes a client device to request data from a specified network location (e.g., URL) in response to user interaction with the search result. An example search result can include a web page title, a snippet of text or a portion of an image extracted from the web page, and the URL of the web page. Another example search result can include a title of a downloadable application, a snippet of text describing the downloadable application, an image depicting a user interface of the downloadable application, and/or a URL to a location from which the application can be downloaded to the client device 106. In some situations, the search system 150 can be part of, or interact with, an application store (or an online portal) from which applications can be downloaded for install at a client device 106 in order to present information about downloadable applications that are relevant to a submitted search query. Like other electronic documents, search results pages can include one or more slots in which digital components (e.g., advertisements, video clips, audio clips, images, or other digital components) can be presented.

The DCDS 110 may determine a standard transmission requirement for transmission of a digital component in response to a request 112 based on the eligibility values of the set of digital components that are eligible for transmission. In some cases, the DCDS 110 determines the standard transmission requirement for transmission of a digital component by an auction process based on the eligibility values of the set of digital components that are eligible for transmission. In some situations, the standard transmission requirements determined by the DCDS 110 may exhibit a high variance between transmissions, even when the characteristics of the transmissions (e.g., digital component requests, digital component distribution criteria, digital component presentation positions, and the like) are similar.

The DCDS 110 may determine formats to be applied to a digital component selected for transmission. Generally, a format for a digital component is an enhancing modification of the digital component. For example, formats may increase a likelihood of user interaction with the digital component when the digital component is presented at a user device. Particular examples of formats include location formats, third-party reviews, consumer and seller ratings, site links, descriptive snippets and text, and previous visits. For example, a digital component may be formatted to include a photo of a user's current location determined using a location format.

The DCDS 110 may determine the formats to be applied to a digital component based on the transmission requirement for the digital component and the eligibility value of the digital component. In particular, the DCDS 110 may increase the transmission requirement for the digital component depending on which formats are applied to the digital component, and the formats that can be applied to a digital component may be restricted by the eligibility value of the digital component. For example, DCDS 110 may determine that a set of one or more formats can be applied to a digital component only if the resulting increased transmission requirement for the digital component does not exceed the eligibility value for the digital component.

When the transmission requirements for similar digital component transmissions exhibit substantial variance (e.g., as do standard transmission requirements), then in some cases, the DCDS 110 may be unable to apply all available formats to digital components. For example, the DCDS 110 may be unable to apply all available formats to a digital component if the transmission requirement for the digital component is unusually high (e.g., due to the variance of the transmission requirements). This can lead to a system that sporadically applies formats to some digital components while not applying formats to other digital components that are similar to those digital components to which formats were applied. This type of sporadic application of formats to digital components is undesirable because it leads to uncertainty regarding how the system will operate in any given situation (e.g., in response to any given request for digital components).

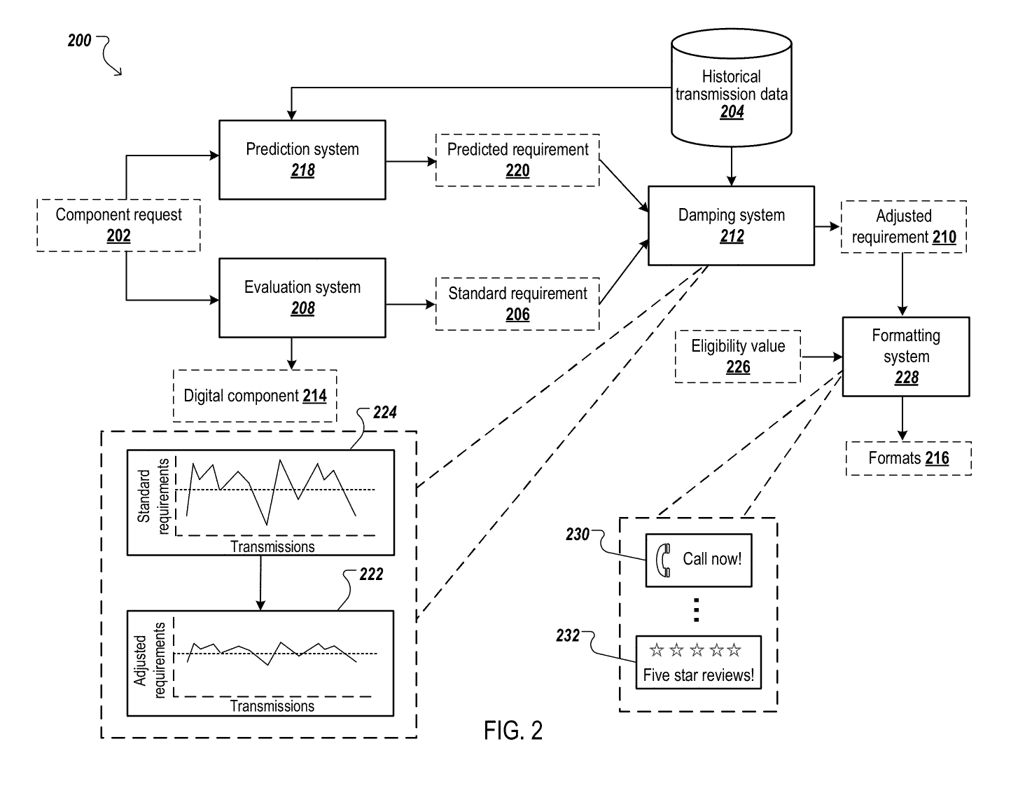

In order to correct the undesirable sporadic application of formats to digital components, and as described in more detail with reference to FIG. 2, the DCDS 110 determines adjusted transmission requirements for digital components that exhibit lower variance between similar digital component transmissions than standard transmission requirements. Therefore, DCDS 110 may be more likely to be able to apply all available formats to digital components if the transmission requirement is determined to be the adjusted transmission requirement rather than the standard transmission requirement. Moreover, the DCDS 110 can prevent unacceptably large discrepancies between the average of the adjusted transmission requirements and the average of the standard transmission requirements for similar transmissions. Furthermore, reducing (i.e. damping) the variation of transmission requirements for similar digital component transmissions improves the functioning of the system itself, for example, by making the system operate in a more predictable fashion.

FIG. 2 is a block diagram of an example data flow 200 for determining an adjusted requirement for a transmission of a digital component and for determining formats to be applied to the digital component.

The data flow 200 can begin with the DCDS 110 receiving a component request 202 from a client device 106. As previously described, the component request 202 includes information that the DCDS 110 can use to select one or more digital components for transmission in response to the request. For example, the component request 202 may specify available positions to present digital components in an electronic document (e.g., presented at the client device 106), media types that are eligible for presentation in the positions, keywords associated with the electronic document, and the like.

The DCDS 110 maintains historical transmission data 204 that indicates, for each of multiple prior digital component transmissions, the standard requirement 206 for the prior transmission (e.g., as generated by the evaluation system 208), the adjusted requirement 210 for the prior transmission (e.g., as generated by the damping system 212), and data characterizing the prior transmission, such as: (i) information included in the component request that triggered the prior transmission, (ii) distribution criteria of the transmitted digital component, (iii) the position in the electronic document at which the transmitted digital component was presented, and the like. The historical transmission data 204 may be represented in any appropriate format (e.g., in a relational database format) and stored in any appropriate manner (e.g., in a logical data storage area or in a physical data storage device).

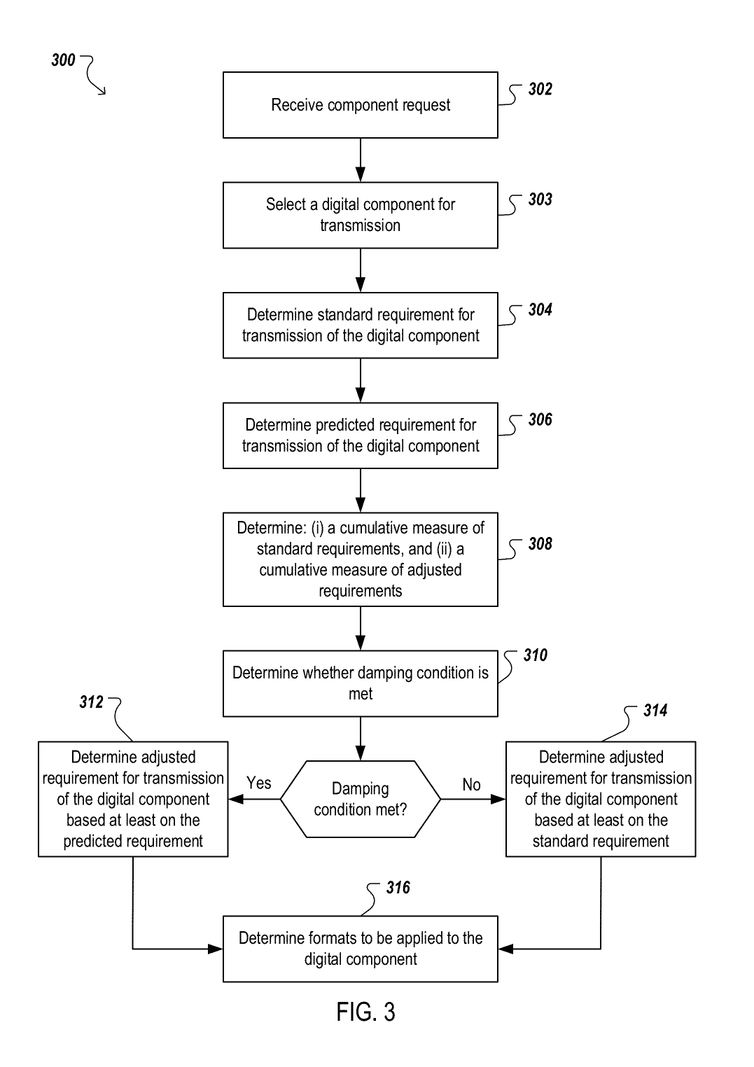

The DCDS 110 provides the component request 202 to an evaluation system 208 that is configured to: (i) select one or more digital components 214 to be transmitted in response to the component request 202, and (ii) determine a respective standard requirement 206 for transmission of each of the selected digital components 214. For example, the evaluation system 208 may perform an auction procedure based on the eligibility values of digital components that are identified as eligible to be transmitted in response to the component request 202 (as will be described further with reference to FIG. 3).

The description which follows describes how the DCDS 110 determines an adjusted requirement 210 (and formats 216) for one of the digital components 214 selected for transmission (e.g., to be presented at a particular position in an electronic document at a client device 106).

The DCDS 110 provides the component request 202 to a prediction system 218 that is configured to generate a predicted requirement 220 for transmission of the digital component 214. In some implementations, the predicted requirement 220 is a largest transmission requirement that enables all available formats to be applied to the digital component 214 (as will be described in more detail later). In some implementations, the predicted requirement 220 reflects an expected value of the standard requirement 206 for transmission of the digital component 214 based on historical transmission data 204. For example, the prediction system 218 may generate the predicted requirement 220 by: (i) identifying multiple prior transmissions in the historical data that are similar to the transmission of digital component 214, and (ii) determining the predicted requirement 220 as an average of the standard requirements for the identified prior transmissions (as will be described further with reference to FIG. 3).

The DCDS 110 provides the standard requirement 206 and the predicted requirement 220 to a damping system 212 that is configured to generate an adjusted requirement 210 for transmission of the digital component 214. The damping system 212 determines, based at least in part on the historical transmission data 204, whether a damping condition is met, and generates the adjusted requirement 210 based on whether the damping condition is met. The damping condition may reflect, for example, whether setting the adjusted requirement 210 to be the predicted requirement 220 would cause an unacceptably large discrepancy (e.g., more than a maximum fractional discrepancy or another appropriate threshold) between a cumulative measure of adjusted requirements (e.g., as described with reference to 308) and a cumulative measure of standard requirements (e.g., as described with reference to 308) determined for similar transmissions.

The adjusted requirements 210 may exhibit a lower variance (e.g. referring to 222) than the standard requirements 206 for the same digital component transmissions (e.g., referring to 224). For example, a standard deviation of the adjusted requirements 210 over multiple transmissions may be lower than a standard deviation of the standard requirements 206 over the same transmissions. In other words, the adjusted requirements 210 over the multiple transmissions may be clustered more tightly about the average adjusted requirement for the multiple transmissions than the standard requirements 206 over the same transmissions are clustered about the average standard requirement for the multiple transmissions. Moreover, an average (or some other cumulative measure) of the adjusted requirements 210 may be similar (within some acceptable margin) to an average (or some other cumulative measure) of the standard requirements 206 for the similar digital component transmissions. For example, in 222 the dashed line depicts the average of the adjusted requirements over multiple transmissions, and in 224 the dashed line depicts the average of the standard requirements over the same transmissions. The dashed lines in 222 and 224 are depicted at a similar level (i.e., indicating that the average of the adjusted requirements is similar to the average of the standard requirements).

The DCDS 110 provides the adjusted requirement 210 and the eligibility value 226 of the digital component 214 to a formatting system 228, that is configured to determine which (if any) formats 216 to apply to the digital component 214. Particular examples of formats include location formats, call buttons (e.g., 230), third-party reviews, consumer and seller ratings (e.g., 232), site links, descriptive snippets and text, and previous visits. Generally, applying a format to the digital component 214 increases the transmission requirement (e.g., the adjusted requirement 210) for the digital component 214, and the formats 216 that can be applied to the digital component 214 may be restricted by the eligibility value 226 of the digital component 214. For example, each format may have a corresponding amount by which the transmission requirement must be increased in order for the format to be applied. As such, when the DCDS 110 applies a format to a particular digital component, the DCDS 110 will increase the transmission requirement by the amount corresponding to the format that was applied. Thus, the DCDS 110 may determine that a set of one or more formats 216 can be applied to the digital component 214 only if the resulting increased transmission requirement for the digital component 214 does not exceed the eligibility value 226 of the digital component 214.

FIG. 3 is a flow diagram of an example process for determining an adjusted requirement for transmission of a digital component and for determining formats to be applied to the digital component. For convenience, the process 300 will be described as being performed by a system of one or more computers located in one or more locations. For example, a digital component distribution system, e.g., the digital component distribution system 110 of FIG. 1, appropriately programmed in accordance with this specification, can perform the process 300.

The system receives a component request from a client device (302). The component request includes information that the system can use to select one or more digital components for transmission in response to the request. For example, the component request may specify available positions to present digital components in an electronic document (e.g., presented at the client device), media types that are eligible for presentation in the positions, keywords associated with the electronic document, and the like.

The system selects a digital component to be transmitted in response to the component request (303). As described with reference to FIG. 1, the system may select a digital component to be transmitted in response to the component request by identifying a set of digital components that are eligible to be transmitted in response to the component request. For example, the system may identify a digital component as eligible if the component request includes at least one criterion (e.g., a keyword criterion) that matches (e.g., exactly, or with some pre-specified level of similarity) one of the distribution parameters of the digital component. The system may select one or more of the eligible digital components to be transmitted through an auction procedure. In some implementations, the system performs an auction procedure by ranking the eligible digital components in accordance with their respective eligibility values, and selecting one or more highest-ranked digital components to be transmitted in response to the component request.

For example, the system may identify digital components A, B, and C as eligible to be transmitted in response to the component request. In this example, digital component A has an eligibility value of $5, digital component B has an eligibility value of $1, and digital component C has an eligibility value of $5.5, where the eligibility values of the digital components represent bids associated with the digital components. The system may rank (e.g., in descending order) the digital components in accordance with their respective eligibility values as: C, A, B. Finally, the system may select the highest ranked digital component C for transmission in response to the component request.

In general, the system can select the digital component to be transmitted in response to the component request using any appropriate selection procedure, including selection procedures that do not include auctions.

For brevity, the description of the steps of the process 300 which follow (i.e., 304-316) are described with reference to a particular digital component selected for transmission in response to the component request. In general, when multiple digital components are selected for transmission, the procedure described in the following steps may be applied with reference to each digital component selected for transmission.

The system determines a standard requirement for transmission of the selected digital component (304). The system may determine the standard requirement for transmission of the selected digital component based on the eligibility value of the selected digital component and/or the eligibility values of the other digital components that were determined (e.g., as described in 303) as eligible to be transmitted in response to the component request.

In some implementations, the system determines the standard requirement for transmission of the selected digital component based on the eligibility value of the selected digital component. In a particular example described with reference to 303, digital components A, B, and C have respective eligibility values (in this case, bids) of $5, $1, and $5.5. Digital component C was selected for transmission, and the system may determine the standard requirement for transmission of digital component C to the eligibility value of C, in this case, $5.5.

In some implementations, the system determines the standard requirement for transmission of the selected digital component based on the eligibility value of another eligible digital component. In the particular example described with reference to 303, digital components A, B, and C have respective eligibility values of $5, $1, and $5.5. The digital components were ranked (in descending order) based on their respective eligibility values as C, A, and B. Digital component C was selected for transmission, and the system may determine the standard requirement for transmission of digital component C to be the next highest eligibility value from amongst the eligibility values of the eligible digital components. In this case, next highest eligibility value is the $5 (i.e., the eligibility value of digital component A), and therefore, the system determines the standard requirement for transmission of digital component A to be $5.

In conventional systems that do not determine an adjusted requirement for transmission of the digital component (e.g., as described with reference to 312 and 314), the transmission requirement for the selected digital component is set to the standard transmission requirement (or within some tolerance range of the standard transmission requirement).

In general, the system can use any appropriate method for determining standard transmission requirements for digital components selected for transmission.

The system determines a predicted requirement for transmission of the digital component (306). In some implementations, the predicted requirement reflects an expected value of the standard requirement (e.g., as determined in 304) for transmission of the digital component. The predicted requirement can be determined, for example, based on historical transmission data maintained by the system. The historical transmission data may indicate, for each of multiple prior digital component transmissions, the standard requirement for the prior transmission (e.g., as determined in 304), the adjusted requirement for the prior transmission (e.g., as determined in 312 and 314), and data characterizing the prior transmission. The data characterizing the prior transmission can specify various characteristics, such as: (i) information included in the component request that triggered the prior transmission, (ii) distribution criteria of the transmitted digital component, (iii) the position in the electronic document at which the transmitted digital component was presented, and the like.

In some of these implementations, the system can determine the predicted requirement for transmission of the digital component based on prior similar transmissions of digital components. For example, the system can identify multiple prior transmissions in the historical data that are determined to be similar to the current transmission, and utilize the data characterizing those prior transmissions for purposes of determining the predicted requirement of the current transmission. The system may identify a prior transmission as similar to the current transmission based on similarities between: (i) the information included in the prior component request that triggered the prior transmission and the information included in the component request that triggered the current transmission, (ii) the distribution criteria of the digital component of the prior transmission and the distribution criteria of the digital component of the current transmission, and/or (iii) the position in the electronic document at which the digital component of the prior transmission was presented and the position in the electronic document at which the digital component of the current transmission is to be presented.

In a particular example, the system may identify a prior transmission as similar to the current transmission if: (i) the distribution criteria of the digital component of the prior transmission and the distribution criteria of the digital component of the current transmission share at least one keyword, and (ii) the position in an electronic document at which the digital component of the prior transmission was presented is the same as the position in an electronic document at which the digital component of the current transmission is to be presented. In some implementations, various measurements of similarity can be used to evaluate the similarity between prior transmissions and the current transmission. For example, characteristics of the different transmissions can be represented as a vector of values corresponding to the various characteristics. Then a similarity measure such as a cosine distance or some other appropriate measure of similarity can be used to determine the level of similarity between the two transmissions. This level of similarity can then be compared to a threshold or some other value to determine whether the level of similarity is high enough for the different transmissions to be considered similar.

In some of these implementations, the system determines the predicted requirement based on the standard requirements for the prior transmissions that are identified as similar to the current transmission. For example, the system may determine the predicted requirement to be an average (or any other combination) of the standard requirements of the prior transmissions that are identified as similar to the current transmission.

In some implementations, the system determines the predicted requirement based on the output of a machine learning model (i.e., a mathematical model trained using machine learning techniques). For example, the model may process an input in accordance with current values of a set of model parameters to generate as output the predicted requirement. The model input may include one or more characteristics of: (i) the information included in the component request, (ii) the distribution criteria of the digital component, and (iii) the position in the electronic document at which the current digital component is to be presented. The model may be trained using training data drawn from the historical transmission data. The model may be implemented as a linear model, a support vector machine (SVM), a random forest, a neural network, or in any other appropriate manner.

In some implementations, the system determines the predicted requirement to be (within some tolerance range of) a largest transmission requirement level at which the digital component is capable of obtaining all available formats (e.g., as described with reference to 316).

In some cases, the system updates the predicted requirement based on the standard requirement to cause a similarity between the predicted requirement and the standard requirement to exceed a threshold. For example, the system may update the predicted requirement cₐ (e.g., as determined in any of the previously described implementations, or in any other appropriate manner) by the relationship:

cₐ←max(cₐ,(1−m)··cₙ),

where cₙ is the standard requirement and m is the largest fractional amount by which the system may lower the adjusted requirement for transmission of the digital component from the standard requirement (e.g., as determined in 312 or 314). As another example, the system may update the predicted requirement cₐ by the relationship:

cₐ←min(cₐ,(1+m)·cₙ),

where m is the largest fractional amount by which the system may raise the adjusted requirement for transmission of the digital component from the standard requirement.

The system determines: (i) a cumulative measure of standard requirements for one or more prior digital component transmissions, and (ii) a cumulative measure of adjusted requirements for one or more prior digital component transmissions (308). In general, the system determines these cumulative measures based on the historical transmission data maintained by the system.

In some cases, the system determines the cumulative measures using a pre-determined number of prior transmissions from the historical transmission data that are determined to be similar to the current transmission (as described earlier). The system may determine the cumulative measure of standard requirements by combining (by any appropriate means) the standard requirements for the identified prior transmissions. For example, the system may determine the cumulative measure of standard requirements by summing (or otherwise combining or aggregating) the standard requirements for the identified prior transmissions. Analogously, the system may determine the cumulative measure of adjusted requirements by combining (by any appropriate means) the adjusted requirements for the identified prior transmissions. For example, the system may determine the cumulative measure of adjusted requirements by summing (or otherwise combining or aggregating) the adjusted requirements for the identified prior transmissions.

The system determines whether a damping condition is met (310). In some implementations, the system determines whether a damping condition is met based on at least: (i) the cumulative measure of standard requirements for the identified prior transmissions, and (ii) the cumulative measure of adjusted requirements for the identified prior transmissions. Next, when the damping condition is met, the system can determine the adjusted requirement for the transmission of the digital component based on at least the predicted requirement (e.g., as determined in 306) (312). When the damping condition is not met, the system can determine the adjusted requirement for the transmission of the digital component based on at least the standard requirement (e.g., as determined in 304) (314).

To determine whether the damping condition is met, the system can determine an updated cumulative measure of standard requirements based on the cumulative measure of standard requirements (e.g., as determined in 308) and the standard requirement for transmission of the digital component (e.g., as determined in 304). For example, the system may determine the updated cumulative measure of standard requirements by summing the cumulative measure of standard requirements and the standard requirement for transmission of the digital component. That is, the system may determine the updated cumulative measure of standard requirements C_{N}′ by the relationship:

C_{N}′=C_{N}cₙ (1)

where C_{N} is the cumulative measure of standard requirements and cₙ is the standard requirement for transmission of the digital component.

Similarly, to determine whether the damping condition is met, the system can determine an updated cumulative measure of adjusted requirements based on the cumulative measure of adjusted requirements (e.g., as determined in 308) and the predicted requirement for transmission of the digital component (e.g., as determined in 306). For example, the system may determine the updated cumulative measure of adjusted requirements by summing the cumulative measure of adjusted requirements and the predicted requirement for transmission of the digital component. That is, the system may determine the updated cumulative measure of adjusted requirements C) by the relationship:

C_{A}′=C_{A}+cₐ (2)

where C_{A} is the cumulative measure of adjusted requirements and cₐ is the predicted requirement for transmission of the digital component.

Descriptions of several example implementations follow. These example implementations are not exhaustive, and other implementations (or combinations of the described implementations) are possible.

In a first example implementation, the system sets the adjusted requirement to be (within some tolerance threshold of) the predicted requirement when doing so would not cause an unacceptably large discrepancy (e.g., more than a maximum allowable fractional discrepancy or another appropriate threshold or trigger point) between the updated cumulative measure of adjusted requirements and the updated cumulative measure of standard requirements. More specifically, the system determines whether a threshold of similarity between the updated cumulative measure of standard requirements and the updated cumulative measure of adjusted requirements is met. For example, the system may determine the threshold level of similarity is met if the following relationship is satisfied:

|C_{N}′−C_{A}′|≤δ·|C_{N}′| (3)

where C_{N}′ is the updated cumulative measure of standard requirements (as described earlier), C_{A}′ is the updated cumulative measure of adjusted requirements (as described earlier), and δ is a maximum allowable fractional discrepancy between the updated cumulative measure of standard requirements and the updated cumulative measure of adjusted requirements. In general, the threshold of similarity between the updated cumulative measure of standard requirements and the updated cumulative measure of adjusted requirements, determined in this implementation based on the maximum allowable fractional discrepancy δ, can be determined by other appropriate means.

In this implementation, the system determines the damping condition to be met when the threshold of similarity between the updated cumulative measure of standard requirements and the updated cumulative measure of adjusted requirements is met (e.g., when (3) is satisfied). When the damping condition is met, the system can set the adjusted requirement for the current transmission to be (within some tolerance threshold of) the predicted requirement for the current transmission (i.e., cₐ). The system determines the damping condition not to be met when the threshold of similarity between the updated cumulative measure of standard requirements and the updated cumulative measure of adjusted requirements is not met (e.g., when (3) is not satisfied). When the damping condition is not met, the system can set the adjusted requirement for the current transmission to be (within some tolerance threshold of) the standard requirement for the current transmission (i.e., cₙ).

In a variant of this implementation, when the system determines that (i) the damping condition (as described earlier, e.g., with reference to (3)) is not met, the system can determine the adjusted requirement based on a combination of the standard requirement and the predicted requirement. For example, if (i) the damping condition is not met, and (ii) the standard requirement is greater than the predicted requirement, then system can set the adjusted requirement to be (within some tolerance threshold of) a smallest value between the predicted requirement and the standard requirement so that the damping condition is met. As another example, if (i) the damping condition is not met, and (ii) the standard requirement for the current transmission is less than the predicted requirement for the current transmission, then the system can set the adjusted requirement to be (within some tolerance threshold of) a largest value between the standard requirement and the predicted requirement so that the damping condition is met.

In a second example implementation, the system may reduce the adjusted requirement from the standard requirement if doing so enables additional formats to be applied to the digital component (e.g., as described with reference to 316), and the system may increase the adjusted requirement from the standard requirement if doing so does not cause fewer formats to be applied to the digital component. For example, the damping condition may be given by a combined damping condition:

D₁ or D₂ (4)

where D₁ is a first damping condition and D₂ is a second damping condition, and the combined damping condition in (4) can be considered to be met when either the first damping condition or the second damping condition is met.

The system can determine the first damping condition to be met when: (i) additional formats would be applied to the digital component if the adjusted requirement were set to (within a tolerance threshold of) the predicted requirement than if it were set to (within a tolerance threshold of) the standard requirement, (ii) the updated cumulative measure of adjusted requirements is less than the updated cumulative measure of standard requirements, and (iii) a threshold of similarity between the updated cumulative measure of standard requirements and the updated cumulative measure of adjusted requirements is met. For example, the system may determine the first damping condition to be met when additional formats would be applied to the digital component if the adjusted requirement were set to the predicted requirement than if the adjusted requirement were set to the standard requirement, and the following expression is valid:

C_{A}′≤C_{N}′ and |C_{N}′−C_{A}′|≤δ·C_{N}′ (5)

where the variables are defined as earlier.

The system can determine the second damping condition to be met when: (i) the same formats would be applied to the digital component irrespective of whether the adjusted requirement were set to (within tolerance thresholds of) the predicted requirement or the standard requirement, (ii) the predicted requirement is greater than the standard requirement, and (iii) the updated cumulative measure of adjusted requirements is less than the updated cumulative measure of standard requirements. For example, the system may determine the second damping condition to be met when the same formats would be applied to the digital component irrespective of whether the adjusted requirement were set to the predicted requirement or the standard requirement, and the following expression is valid:

cₐ>cₙ and C_{A}′≤C_{N}′ (6)

where the variables are defined as earlier.

In this implementation, when the damping condition (4) is met, the system can set the adjusted requirement for the current transmission to be (within a tolerance threshold of) the predicted requirement (i.e., cₐ). When the damping condition (4) is not met, the system can set the adjusted requirement to be (within a tolerance threshold of) the standard requirement (i.e., cₙ).

The system determines formats to be applied to the digital component (316). Particular examples of formats include location formats, call buttons, third-party reviews, consumer and seller ratings, site links, descriptive snippets and text, and previous visits. Generally, applying a format to the digital component increases the transmission requirement (i.e., the adjusted transmission requirement, as determined in 312 or 314) for the digital component, and the formats that can be applied to the digital component may be restricted by the eligibility value of the digital component. For example, the system may determine that a set of one or more formats can be applied to the digital component only if the resulting increased transmission requirement for the digital component does not exceed the eligibility value of the digital component. In this example, the system may determine the set of formats to be applied to the digital component to be a set of formats that maximally increases the transmission requirement for the digital component without exceeding the eligibility value of the digital component.

In some implementations, each format may be associated with a corresponding factor reflecting an expected increase in utility of the digital component that would be achieved by applying the format to the digital component. For example, the factor for a format may reflect an expected rate of increase in interactions with the digital component at the client device (e.g., clicks) when the format is applied to the digital component. In some of these implementations, the system determines the increased transmission requirement T for the digital component based on the factors corresponding to the formats applied to the digital component by the relationship:

$$T = ( 1 + {\sum }_{i = 1}^{N} {α}_{i} ) \cdot {c}_{adj} \qquad ( 7 )$$

where N is the number of formats applied to the digital component, αᵢ is the factor associated with format i, and c_{adj} is the adjusted requirement for transmission of the digital component (i.e., as determined in 312 or 314).

The system may determine the increased transmission requirement for the digital component after applying formats to the digital component (e.g., in accordance with (7)) by accessing format data indicating the factors associated with each format. The format data may be represented in any appropriate format (e.g., in a relational database), and stored in any appropriate location (e.g., in a logical data storage area or on a physical data storage device). The system may match the formats to be applied to the digital component with the factor associated with each format as indicated in the format data, and subsequently apply the factors to determine the increased transmission requirement.

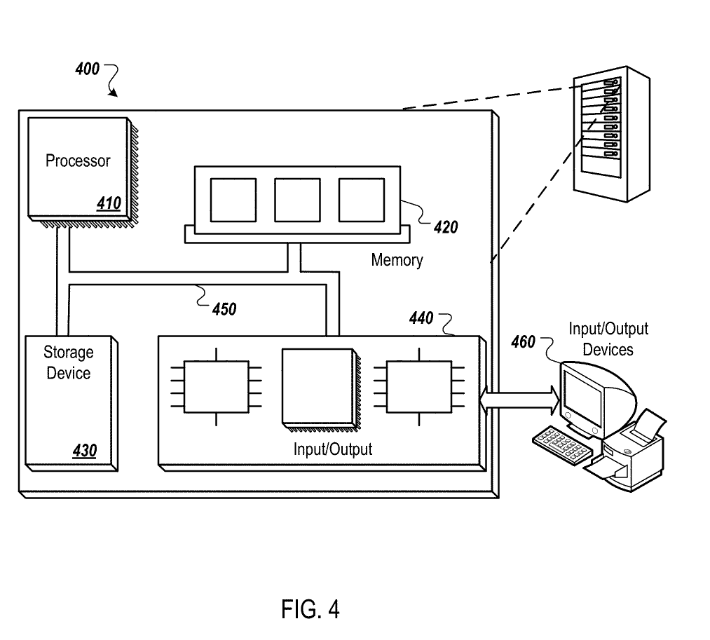

FIG. 4 is block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a sub combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system comprising:
an evaluation subsystem that is configured to determine a standard requirement for transmission of a given digital component;
a prediction subsystem that is configured to determine a predicted requirement for transmission of the given digital component;
a damping subsystem that is configured to determine an adjusted requirement for transmission of the given digital component, wherein the damping subsystem determines the adjusted requirement by performing operations comprising:
obtaining, from the evaluation subsystem, the standard requirement for transmission of the given digital component as determined by the evaluation subsystem;
obtaining, from the prediction subsystem, the predicted requirement for transmission of the given digital component as determined by the prediction subsystem;
determining an adjusted requirement for transmission of the given digital component, including:
determining: (i) a cumulative measure of standard requirements for one or more previous transmissions of digital components, and (ii) a cumulative measure of adjusted requirements for the one or more previous transmissions of digital components;
determining whether a damping condition is met based on at least: (i) the cumulative measure of standard requirements for previous transmissions of digital components, and (ii) the cumulative measure of adjusted requirements for previous transmissions of digital components;
determining the adjusted requirement based on at least the predicted requirement when the damping condition is met; and
determining the adjusted requirement based on at least the standard requirement when the damping condition is not met.

2. The system of claim 1, wherein determining whether the damping condition is met includes:
determining an updated cumulative measure of standard requirements based on the cumulative measure of standard requirements and the standard requirement for transmission of the given digital component;
determining an updated cumulative measure of adjusted requirements based on the cumulative measure of adjusted requirements and the predicted requirement for transmission of the given digital component;
determining whether a threshold of similarity between the updated cumulative measure of standard requirements and the updated cumulative measure of adjusted requirements is met; and
determining the damping condition is met based on at least the threshold similarity being met, and determining the damping condition is not met based on at least the threshold similarity not being met.

3. The system of claim 1, wherein determining whether the damping condition is met includes:
determining an updated cumulative measure of standard requirements based on the cumulative measure of standard requirements and the standard requirement for transmission of the given digital component;
determining an updated cumulative measure of adjusted requirements based on the cumulative measure of adjusted requirements and the predicted requirement for transmission of the given digital component;
determining whether the updated cumulative measure of adjusted requirements is less than the updated cumulative measure of standard requirements; and
determining the damping condition is met based on at least the updated cumulative measure of adjusted requirements being less than the updated cumulative measure of standard requirements, and determining the damping condition is not met based on at least the updated cumulative measure of adjusted requirements not being less than the updated cumulative measure of standard requirements.

4. The system of claim 1, wherein determining whether the damping condition is met includes:
determining whether additional formats would be applied to the digital component if the adjusted requirement were determined to be the predicted requirement; and
determining the damping condition is met based on at least additional formats being applied if the adjusted requirement were determined to be the predicted requirement, and determining the damping condition is not met based on at least additional formats not being applied if the adjusted requirement were determined to be the predicted requirement.

5. The system of claim 1, wherein the predicted requirement for transmission of the given digital component is determined to be an average of previous standard requirements for transmissions of digital components.

6. The system of claim 1, wherein the predicted requirement for transmission of the given digital component is determined to be a requirement level at which the given digital component is capable of obtaining all available formats.

7. The system of claim 1, wherein determining the predicted requirement for transmission of the given digital component comprises:
updating the predicted requirement based on the standard requirement to cause a similarity between the updated predicted requirement and the standard requirement to exceed a threshold.

8. The system of claim 1, further comprising formatting the given digital component based on the adjusted requirement.

9. A computer-implemented method for determining an adjusted requirement for transmission of a given digital component, the method comprising:
determining, by an evaluation subsystem, a standard requirement for transmission of the given digital component;
determining, by a prediction subsystem, a predicted requirement for transmission of the given digital component;
determining, by a damping subsystem, an adjusted requirement for transmission of the given digital component, including:
determining: (i) a cumulative measure of standard requirements for one or more previous transmissions of digital components, and (ii) a cumulative measure of adjusted requirements for the one or more previous transmissions of digital components;
determining whether a damping condition is met based on at least: (i) the cumulative measure of standard requirements for previous transmissions of digital components, and (ii) the cumulative measure of adjusted requirements for previous transmissions of digital components;
determining the adjusted requirement based on at least the predicted requirement when the damping condition is met; and
determining the adjusted requirement based on at least the standard requirement when the damping condition is not met.

10. The method of claim 9, wherein determining whether the damping condition is met includes:
determining an updated cumulative measure of standard requirements based on the cumulative measure of standard requirements and the standard requirement for transmission of the given digital component;
determining an updated cumulative measure of adjusted requirements based on the cumulative measure of adjusted requirements and the predicted requirement for transmission of the given digital component;
determining whether a threshold of similarity between the updated cumulative measure of standard requirements and the updated cumulative measure of adjusted requirements is met; and
determining the damping condition is met based on at least the threshold similarity being met, and determining the damping condition is not met based on at least the threshold similarity not being met.

11. The method of claim 9, wherein determining whether the damping condition is met includes:
determining an updated cumulative measure of standard requirements based on the cumulative measure of standard requirements and the standard requirement for transmission of the given digital component;
determining an updated cumulative measure of adjusted requirements based on the cumulative measure of adjusted requirements and the predicted requirement for transmission of the given digital component;
determining whether the updated cumulative measure of adjusted requirements is less than the updated cumulative measure of standard requirements; and
determining the damping condition is met based on at least the updated cumulative measure of adjusted requirements being less than the updated cumulative measure of standard requirements, and determining the damping condition is not met based on at least the updated cumulative measure of adjusted requirements not being less than the updated cumulative measure of standard requirements.

12. The method of claim 9, wherein determining whether the damping condition is met includes:
determining whether additional formats would be applied to the digital component if the adjusted requirement were determined to be the predicted requirement; and
determining the damping condition is met based on at least additional formats being applied if the adjusted requirement were determined to be the predicted requirement, and determining the damping condition is not met based on at least additional formats not being applied if the adjusted requirement were determined to be the predicted requirement.

13. The method of claim 9, wherein the predicted requirement for transmission of the given digital component is determined to be an average of previous standard requirements for transmissions of digital components.

14. The method of claim 9, wherein the predicted requirement for transmission of the given digital component is determined to be a requirement level at which the given digital component is capable of obtaining all available formats.

15. The method of claim 9, wherein determining the predicted requirement for transmission of the given digital component comprises:
updating the predicted requirement based on the standard requirement to cause a similarity between the updated predicted requirement and the standard requirement to exceed a threshold.

16. The method of claim 9, further comprising formatting the given digital component based on the adjusted requirement.

17. A non-transitory computer storage medium storing instructions executable by a data processing apparatus and that upon such execution cause the data processing apparatus to determine an adjusted requirement for transmission of a given digital component by performing operations comprising:
determining a standard requirement for transmission of the given digital component;
determining a predicted requirement for transmission of the given digital component;
determining an adjusted requirement for transmission of the given digital component, including:
determining: (i) a cumulative measure of standard requirements for one or more previous transmissions of digital components, and (ii) a cumulative measure of adjusted requirements for the one or more previous transmissions of digital components;
determining whether a damping condition is met based on at least: (i) the cumulative measure of standard requirements for previous transmissions of digital components, and (ii) the cumulative measure of adjusted requirements for previous transmissions of digital components;
determining the adjusted requirement based on at least the predicted requirement when the damping condition is met; and
determining the adjusted requirement based on at least the standard requirement when the damping condition is not met.

18. The non-transitory computer storage medium of claim 17, wherein determining whether the damping condition is met includes:
determining an updated cumulative measure of standard requirements based on the cumulative measure of standard requirements and the standard requirement for transmission of the given digital component;
determining an updated cumulative measure of adjusted requirements based on the cumulative measure of adjusted requirements and the predicted requirement for transmission of the given digital component;
determining whether a threshold of similarity between the updated cumulative measure of standard requirements and the updated cumulative measure of adjusted requirements is met; and
determining the damping condition is met based on at least the threshold similarity being met, and determining the damping condition is not met based on at least the threshold similarity not being met.

19. The non-transitory computer storage medium of claim 17, wherein determining whether the damping condition is met includes:
determining an updated cumulative measure of standard requirements based on the cumulative measure of standard requirements and the standard requirement for transmission of the given digital component;
determining an updated cumulative measure of adjusted requirements based on the cumulative measure of adjusted requirements and the predicted requirement for transmission of the given digital component;
determining whether the updated cumulative measure of adjusted requirements is less than the updated cumulative measure of standard requirements; and
determining the damping condition is met based on at least the updated cumulative measure of adjusted requirements being less than the updated cumulative measure of standard requirements, and determining the damping condition is not met based on at least the updated cumulative measure of adjusted requirements not being less than the updated cumulative measure of standard requirements.

20. The non-transitory computer storage medium of claim 17, wherein determining whether the damping condition is met includes:
determining whether additional formats would be applied to the digital component if the adjusted requirement were determined to be the predicted requirement; and
determining the damping condition is met based on at least additional formats being applied if the adjusted requirement were determined to be the predicted requirement, and determining the damping condition is not met based on at least additional formats not being applied if the adjusted requirement were determined to be the predicted requirement.
